(19) United States
(12) Patent Application Publication
(10) Pub. No.: US 2025/0118234 A1
(43) Pub. Date: Apr. 10, 2025

(54) ELECTRONIC DEVICE AND CONTROLLING METHOD THEREOF

(71) Applicant: Samsung Electronics Co., Ltd., Suwon-si (KR)

(72) Inventors: Jaesung PARK, Suwon-si (KR); Dongyoon KIM, Suwon-si (KR)

(21) Appl. No.: 18/933,104

(22) Filed: Oct. 31, 2024

Related U.S. Application Data
(63) Continuation of application No. PCT/KR2024/015174, filed on Oct. 7, 2024.

(30) Foreign Application Priority Data
Oct. 6, 2023 (KR) 10-2023-0133746

(51) Int. Cl. G09G 3/00; G06F 3/01

(52) U.S. Cl. CPC G09G 3/001; G06F 3/013; G09G 2320/0626; G09G 2320/066; G09G 2340/0407; G09G 2354/00

(57) ABSTRACT

An electronic device and a controlling method thereof are provided. For example, the electronic device may include: a projection unit including a projector, at least one sensor, a memory configured to store at least one instruction, and at least one processor, individually and/or collectively, configured to execute the at least one instruction, and at least one processor, individually and/or collectively, is configured to: obtain information regarding a first distance between the electronic device and a screen through the at least one sensor, obtain information regarding a second distance between the electronic device and a user through the at least one sensor, obtain information regarding a third distance between the user and the screen based on the information regarding the first distance and the information regarding the second distance, adjust at least one parameter related to a quality of a projected image based on the information regarding the first distance, the information regarding the third distance and information regarding visual acuity of the user, and control the projection unit to emit light corresponding to the image based on the adjusted at least one parameter.

### CROSS-REFERENCE TO RELATED APPLICATIONS

This application is a continuation of International Application No. PCT/KR2024/015174 designating the United States, filed on Oct. 7, 2024, in the Korean Intellectual Property Receiving Office and claiming priority to Korean Patent Application No. 10-2023-0133746, filed on Oct. 6, 2023, in the Korean Intellectual Property Office, the disclosures of each of which are incorporated by reference herein in their entireties.

### BACKGROUND

### Field

The disclosure relates to an electronic device and a controlling thereof and for example, to an electronic device capable of providing a projected image with a quality suitable for a user's visual acuity and a controlling method thereof.

### Description of Related Art

Recently, technological advances in electronic devices capable of projecting images, so-called projection units, have been accelerating. In particular, in recent years, ultra-short throw projection units that can project images onto a screen even when the distance to the screen is very short have been provided to eliminate/reduce restrictions on the installation location of the projection units, and a portable projection unit or a mobile projection unit that can project images freely without being restricted by location have been attracting attention.

However, a portable projection unit or a mobile projection unit is characterized in that, unlike a fixed-location projection unit, the location of the projection unit and the location of the screen are variable, so the distance between the projection unit and the screen and the distance between the user and the screen are also variable. Therefore, in the case of a portable projection unit or a mobile projection unit, the size and brightness of the image projected by the projection unit onto the screen may change depending on the location of the projection unit, screen, and user, which may result in degradation of the projected image quality.

Meanwhile, as a prior art for a fixed-location projection unit, there is a technology for improving the image quality of a projected image based on a predefined viewing distance (e.g., the distance between the user and the screen), but there is a limitation in that such a technology cannot be applied as it is to a portable projection unit or a mobile projection unit with variable viewing distances.

In addition, although there is a technology for adjusting the size and shape of a projected image by performing functions such as zooming in/out, keystone correction, lens shift, etc. when the location of at least one of the projection unit, screen or user changes, there is a limitation in that the technology does not provide a projected image with an improved image quality by compensating image quality degradation of the projected image due to the change in location. In other words, the prior art technology does not improve the image quality of the projected image by considering various image quality variations of a portable projection unit or a mobile projection unit.

### SUMMARY

Embodiments of the disclosure address the limitations of the prior art as described above, and to provide an electronic device capable of providing a projected image of an image quality suitable for the user's visual acuity even if at least one of the locations of the electronic device, the screen or the user changes and a controlling method thereof.

An electronic device according to an example embodiment includes: a projection unit comprising a projector, at least one sensor, a memory configured to store at least one instruction, and at least one processor, comprising processing circuitry, individually and/or collectively, configured to execute the at least one instruction, and configured to: obtain information regarding a first distance between the electronic device and a screen through the at least one sensor, obtain information regarding a second distance between the electronic device and a user through the at least one sensor, obtain information regarding a third distance between the user and the screen based on the information regarding the first distance and the information regarding the second distance, adjust at least one parameter related to a quality of a projected image based on the information regarding the first distance, the information regarding the third distance and information regarding visual acuity of the user, and control the projection unit to emit light corresponding to the image based on the adjusted at least one parameter.

The at least one parameter may include a parameter regarding at least one of contrast, sharpness, color, or contrast enhancement of the projected image.

At least one processor, individually and/or collectively, may be configured to: obtain information regarding a size of the projected image based on the information regarding the first distance, obtain information regarding brightness of the projected image based on the information regarding the size of the projected image, and adjust the at least one parameter based on the information regarding the brightness of the projected image.

At least one processor may, individually and/or collectively, be configured to: obtain information regarding contrast sensitivity perceivable by the user based on the information regarding the visual acuity of the user and adjust the at least one parameter based on the information regarding the contrast sensitivity and the information regarding the third distance.

At least one processor, individually and/or collectively, may be configured to: based on a request for providing an image being received, control the projection unit to emit light corresponding to the image, based on the light emitted through the projection unit being projected onto a screen, identify a size and shape of the projected image projected onto the screen through the at least one sensor, perform a keystone correction on the projected image based on the identified size and shape, obtain information regarding a size of the projected image corrected according to the keystone correction, and further adjust the at least one parameter based on the information regarding the size of the corrected projected image.

At least one processor, individually and/or collectively, may be configured to: further adjust the at least one parameter based on the information regarding the size of the corrected projected image to compensate for degradation in resolution of the projected image based on the size of the projected image being reduced by the keystone correction.

At least one processor, individually and/or collectively, may be configured to: identify a set of parameters corresponding to the information regarding the size, the first distance information, the third distance information, and the information regarding the visual acuity of the user from among a plurality of sets of parameters stored in the memory, and adjust the at least one parameter by interpolating the identified set of parameters and at least one parameter included in each of a set of parameters that are currently set.

At least one processor, individually and/or collectively, may be configured to: control the projection unit to emit light corresponding to a user interface, and based on an input for selecting one of a plurality of UI items included in the user interface being received, and adjust the at least one parameter based on the input.

The user interface may include a graph representing contrast sensitivity corresponding to the visual acuity of the user and a plurality of UI items representing each of a plurality of locations of the graph.

At least one processor, individually and/or collectively, may be configured to: obtain a set of parameters for adjusting at least one parameter related to a quality of a projected image by inputting the information regarding the first distance, the information regarding the third distance and the information regarding the visual acuity of the user to a trained neural network model, and adjust the at least one parameter based on the obtained set of parameters.

A method of controlling an electronic device according to an example embodiment includes: obtaining information regarding a first distance between the electronic device and a screen through the at least one sensor, obtaining information regarding a second distance between the electronic device and a user through the at least one sensor, obtaining information regarding a third distance between the user and the screen based on the information regarding the first distance and the information regarding the second distance, adjusting at least one parameter related to a quality of a projected image based on the information regarding the first distance, the information regarding the third distance and information regarding visual acuity of the user, and projecting the image based on the adjusted at least one parameter.

The at least one parameter may include a parameter regarding at least one of contrast, sharpness, color, or contrast enhancement of the projected image.

The method of controlling the electronic device may further include: obtaining information regarding a size of the projected image based on the information regarding the first distance and obtaining information regarding brightness of the projected image based on the information regarding the size of the projected image, and the adjusting at least one parameter may include adjusting the at least one parameter based on the information regarding the brightness of the projected image.

The method of controlling the electronic device may further include: obtaining information regarding contrast sensitivity perceivable by the user based on the information regarding the visual acuity of the user, and the adjusting at least one parameter may include adjusting the at least one parameter based on the information regarding the contrast sensitivity and the information regarding the third distance.

The method of controlling the electronic device may include: based on a request for providing an image being received, controlling the projection unit to emit light corresponding to the image, based on the light emitted through the projection unit being projected onto a screen, identifying a size and shape of the projected image projected onto the screen through the at least one sensor, performing a keystone correction on the projected image based on the identified size and shape, obtaining information regarding a size of the projected image corrected according to the keystone correction, and further adjusting the at least one parameter based on the information regarding the size of the corrected projected image.

The further adjusting the at least one parameter may include further adjusting the at least one parameter based on the information regarding the size of the corrected projected image to compensate for degradation in resolution of the projected image based on the size of the projected image being reduced by the keystone correction

The further adjusting the at least one parameter may include: identifying a set of parameters corresponding to the information regarding the size, the first distance information, the third distance information, and the information regarding the visual acuity of the user from among a plurality of sets of parameters stored in the memory, and adjusting the at least one parameter by interpolating the identified set of parameters and at least one parameter included in each of a set of parameters that are currently set.

The method of controlling the electronic device may further include: projecting a user interface, wherein the adjusting the at least one parameter may include, based on an input for selecting one of a plurality of UI items included in the user interface being received, and adjusting the at least one parameter based on the input.

The user interface may include a graph representing contrast sensitivity corresponding to the visual acuity of the user and a plurality of UI items representing each of a plurality of locations of the graph.

According to an example embodiment, in a non-transitory computer-readable recording medium including a program that when executed by at least one processor, individually and/or collectively, of an electronic device, causes the electronic device to perform a controlling method comprising: obtaining information regarding a first distance between the electronic device and a screen through the at least one sensor, obtaining information regarding a second distance between the electronic device and a user through the at least one sensor, obtaining information regarding a third distance between the user and the screen based on the information regarding the first distance and the information regarding the second distance, adjusting at least one parameter related to a quality of a projected image based on the information regarding the first distance, the information regarding the third distance and information regarding visual acuity of the user, and projecting the image based on the adjusted at least one parameter.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a diagram illustrating a plurality of modules according to various embodiments;

FIG. 3 is a diagram illustrating an example process of obtaining distance information according to various embodiments;

FIG. 4 is a diagram illustrating example keystone correction and a process of adjusting a parameter according to various embodiments;

FIG. 5 is a diagram illustrating an example user interface according to various embodiments;

FIG. 6 is a diagram illustrating an example user interface according to various embodiments;

FIG. 7 is a block diagram illustrating an example configuration of an electronic device according to various embodiments; and

FIG. 8 is a flowchart illustrating an example method of controlling an electronic device according to various embodiments.

### DETAILED DESCRIPTION

Since the disclosure may be variously modified and have several example embodiments, various example embodiments of the disclosure will be illustrated in the drawings and be described in greater detail in the detailed description. However, it is to be understood that the disclosure are not limited to the example embodiments, but includes all modifications, equivalents, and/or alternatives according to various example embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor may be omitted.

In addition, the following example embodiments may be modified in several different forms, and the scope and spirit of the disclosure are not limited to the following example embodiments. Rather, these example embodiments are provided to describe the spirit of the disclosure to those skilled in the art.

Terms used in the disclosure are used simply to describe various example embodiments rather than limiting the scope of the disclosure. Singular forms are intended to include plural forms unless the context clearly indicates otherwise.

In the disclosure, the expressions “have”, “may have”, “include” and or “may include” used herein indicate existence of corresponding features (e.g., elements such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1^{st},” “2^{nd},” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element or an intervening element (e.g., a third element) may be present. When an element (e.g., a first element) is referred to as being “directly coupled with/to” or “directly connected to” another element (e.g., a second element), it should be understood that there are no intervening elements (e.g., a third element).

On the other hand, when it is described that an element (e.g., first element) is “directly coupled with/to” or “directly connected to” another element (e.g., second element), it may be understood that no element (e.g., third element) may exist between the element and the other element.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily refer, for example, to being “specifically designed to” in hardware.

Instead, an expression “˜an apparatus configured to” may refer, for example, to the apparatus “is capable of” together with other apparatuses or components. For example, a “processor configured (or set) to perform A, B, and C” may refer, for example, to a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

In the example embodiments, a “module” or a “unit” may perform at least one function or operation, and be implemented by hardware or software or be implemented by a combination of hardware and software. In addition, a plurality of “modules” or a plurality of “units” may be integrated in at least one module and be implemented by at least one processor except for a ‘module’ or a ‘unit’ that needs to be implemented by specific hardware.

Various elements and regions in the drawings are schematically drawn. Therefore, the technical concept of the disclosure is not limited by a relative size or spacing drawn in the accompanying drawings.

Hereinafter, various example embodiments according to the present disclosure will be described in greater detail with reference to the accompanying drawings.

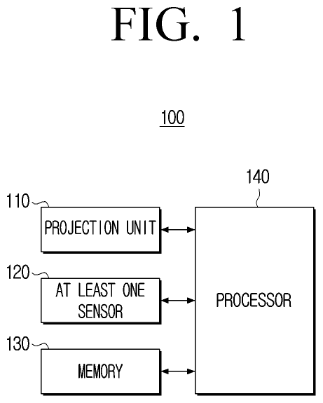

FIG. 1 is a block diagram illustrating an example configuration of an electronic device 100 according to various embodiments.

The ‘electronic device 100’ refers to a device capable of projecting an image onto a screen. For example, for example, the electronic device 100 may be implemented as a device of the type referred to as a beam projection unit or a projection unit, as well as a device such as a movable projector, a portable projector, and the like. Further, the electronic device 100 may be implemented by mounting a projection unit 110 on various types of devices, such as smartphones, tablet PCs, robots, and the like. In other words, there is no particular limitation to the type of the electronic device 100 according to the present disclosure.

As shown in FIG. 1, the electronic device 100 may include the projection unit (e.g., including a projector) 110, at least one sensor 120, a memory 130, and a processor (e.g., including processing circuitry) 140.

The ‘projection unit 110’ refers to configuration that emits light corresponding to an image in order to project the image onto a screen. The term ‘emit’ may be replaced by the term ‘radiate’ or the like. There may be one projection unit 110 or multiple projection units 110. If there are a plurality of projection units 110, the plurality of projection units 110 may include a first projection unit 110 that emits light to be provided to the left eye of the user and a second projection unit 110 that emits light to be provided to the right eye of the user.

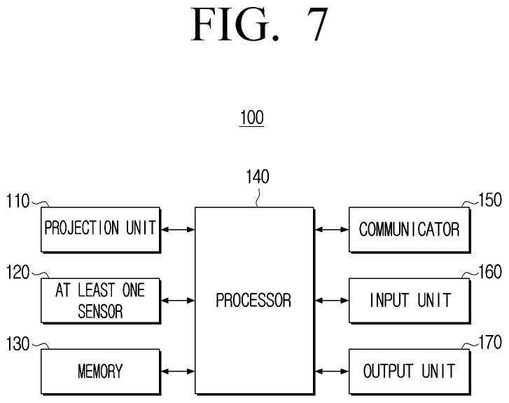

The projection unit 110 may include various detailed configurations, such as a light source, a projection lens, a reflector, and the like, and may perform various functions related to the projected image. An example configuration and various functions of the projection unit 110 will be described in greater detail below with reference to FIG. 7.

A “screen” refers to configuration that may reflect light emitted through the projection unit 110 and provide it to the user. The screen may be fixedly attached to a wall or object in a viewing space, or any wall or object located in the viewing space may itself serve as a screen. The screen may also be implemented as a separate object that is capable of being moved or rolled. There is no particular limitation to the type of screens according to the present disclosure.

The at least one sensor 120 may obtain a variety of information inside and outside of the electronic device 100. In particular, the at least one sensor 120 may include at least one of a variety of sensors capable of obtaining information regarding a distance to an object, such as an image sensor (e.g., a camera), a lidar sensor, a laser sensor, an ultrasonic sensor, an infrared sensor, a time-of-flight sensor, a color visual acuity sensor, and the like.

For example, according to various embodiments, the at least one sensor 120 may obtain information regarding a distance between the electronic device 100 and the screen and information regarding a distance between the electronic device 100 and the user. For example, if the at least one sensor 120 includes a time-of-flight (TOF) sensor, the TOF sensor may obtain information regarding a distance between the electronic device 100 and the screen and information regarding a distance between the electronic device 100 and the user based on the velocity of light emitted by the sensor.

If the at least one sensor 120 includes an image sensor, the image sensor may obtain information regarding a distance between the electronic device 100 and the screen and information regarding a distance between the electronic device 100 and the user by obtaining an image of the screen or an image of the user. The process of obtaining information regarding the distance between the electronic device 100 and the screen and information regarding the distance between the electronic device 100 and the user using the image sensor may be performed by the processor 140, so details related to obtaining information regarding the distance will be described in the description of the processor 140.

The memory 130 may store at least one instruction for the electronic device 100. Further, the memory 130 may store an operating system (O/S) for operating the electronic device 100. The memory 130 may also store various software programs or applications for operating the electronic device 100 according to various embodiments of the present disclosure. The memory 130 may include a semiconductor memory such as flash memory, or magnetic storage media such as a hard disk, or the like.

For example, the memory 130 may store various software modules for operating the electronic device 100 according to various embodiments of the present disclosure, and the processor 140 may control the operation of the electronic device 100 by executing the various software modules stored in the memory 130. In other words, the memory 130 may be accessed by the processor 140, and the data may be read/written/modified/deleted/updated, etc. by the processor 140.

In addition, the term ‘memory 130’ may be used in this disclosure to include ROM, RAM in processor 140, or a memory card (e.g., micro SD card, memory stick) mounted in the electronic device 100.

For example, according to various embodiments, the memory 130 may store various information/data/signals, such as information regarding an image, information regarding a plurality of parameter sets related to a quality of a projected image, information regarding a first distance, information regarding a second distance, information regarding a third distance, information regarding the user's visual acuity, information regarding contrast sensitivity corresponding to the user's visual acuity, information regarding a keystone correction, and the like.

In addition, various other information necessary within the scope of accomplishing the purposes of this disclosure may be stored in memory 130, and information stored in memory 130 may be updated as various information is received from external devices or entered by the user.

The processor 140 may include various processing circuitry and controls the overall operations of the electronic device 100. For example, the processor 140 may be coupled to configuration of the electronic device 100 that includes the projection unit 110, the at least one sensor 120, and the memory 130, and may control the overall operations of the electronic device 100 by, for example, and without limitation, executing at least one instruction stored in the memory 130.

The processor 140 may be implemented in a variety of ways. For example, the processor 140 may be implemented as at least one of an Application Specific Integrated Circuit (ASIC), an embedded processor, a microprocessor, hardware control logic, a hardware Finite State Machine (FSM), and a Digital Signal Processor (DSP). Meanwhile, the term ‘processor 140’ may be used in this disclosure to include a central processing unit (CPU), a graphics processing unit (GPU), a micro-processor unit (MPU), and the like. The processor 140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, according to various embodiments, the processor 140 may adjust at least one parameter related to a quality of a projected image based on information regarding a distance between the electronic device 100, the screen, and the user when at least one of the locations of the electronic device 100, the screen, and the user changes.

For example, the processor 140 may obtain information regarding a first distance between the electronic device 100 and the screen via the at least one sensor 120. In addition, the processor 140 may obtain information regarding a second distance between the electronic device 100 and the user via the at least one sensor 120.

As described above, the at least one sensor 120 may include at least one of a variety of sensors capable of obtaining information regarding a distance to an object, and may utilize at least one of the variety of sensors to obtain information regarding the first distance and information regarding the second distance. The term ‘first distance’ may be used to refer to a distance between the electronic device 100 and the screen, and the term ‘second distance’ is used to refer to a distance between the electronic device 100 and the user.

For example, if the at least one sensor 120 is a time-of-flight (TOF) sensor, the processor 140 may obtain the first distance information regarding the distance between the electronic device 100 and the screen based on the velocity of light emitted by the TOF sensor.

Further, the processor 140 may obtain information regarding the second distance between the electronic device 100 and the user based on an Ω shape size of the user. For example, the processor 140 may obtain information regarding the second distance between the electronic device 100 and the user by obtaining an image of the user via the image sensor, identifying a face size of the user by detecting an Ω shape in the image of the user, and comparing the identified face size of the user to a preset face size or a previously detected face size.

The processor 140 may also obtain information regarding the second distance between the electronic device 100 and the user by obtaining an image of the user via the image sensor, identifying a distance between the user's binocular eyes in the image of the user, and comparing the identified distance between the user's binocular eyes to a preset distance between the binocular eyes or a previously detected distance between the binocular eyes.

Once the information regarding the first distance and the information regarding the second distance are obtained, the processor 140 may obtain information regarding a third distance between the user and the screen of the electronic device 100 based on the information regarding the first distance and the information regarding the second distance. In the description of the present disclosure, the term ‘third distance’ is used to refer to a distance between the user and the screen.

For example, the processor 140 may obtain the third distance using triangulation. For example, the processor 140 may obtain information regarding the third distance using information regarding an angle between the directions facing each of the first distance and the second distance, in conjunction with the information regarding the first distance and the information regarding the second distance. The angle between the directions facing each of the first distance and the second distance may be calculated based on an angle between a direction emitting light from a sensor used to measure the first distance and a direction emitting light from a sensor used to measure the second distance.

Based on the information regarding the first distance, the information regarding the third distance, and the information regarding the user's visual acuity, the processor 140 may adjust at least one parameter related to a quality of a projected image.

Adjusting the at least one parameter based on the information regarding the first distance, the information regarding the third distance, and the information regarding the user's visual acuity may refer, for example, to performing adjusting the at least one parameter based on the information regarding the first distance, adjusting the at least one parameter based on the information regarding the third distance, and adjusting the at least one parameter based on the information regarding the user's visual acuity independently, or may refer, for example, to performing adjusting the at least one parameter using the information regarding the first distance, the information regarding the third distance, and the information regarding the user's visual acuity together.

The term ‘at least one parameter’ may be used to collectively refer to a parameter related to an image quality of a projected image, and may be substituted for terms such as ‘image quality setting value’, ‘image quality adjustment value’, and the like. For example, the at least one parameter may include a parameter for at least one of contrast, sharpness, color, or contrast enhancement of the projected image. In addition, the at least one parameter may include various parameters related to image quality enhancement, such as setting an outline emphasis.

For example, the at least one parameter may include one or more first parameters for at least one of contrast, sharpness, color, or contrast enhancement of the projected image, and one or more second parameters that change together as the one or more first parameters change. ‘Contrast enhancement’ may refer, for example, to a parameter for making a difference between dark and light areas more apparent, or for making details more visible on a dark background.

For example, the memory 130 may store a plurality of parameter sets, each of the plurality of parameter sets being a set of at least one parameter related to image quality. The plurality of parameter sets may each correspond to a ‘mode’ related to the operation of the electronic device 100, such as a first image quality enhancement mode, a second image quality enhancement mode, an image quality emphasis mode (strong), an image quality emphasis mode (weak), and the like.

The plurality of parameter sets may be established through clinical trials. For example, the plurality of parameter sets may be obtained by providing images corresponding to different parameter sets to a number of users with varying acuities, including low visual acuity and blind users, with the locations of the electronic device 100, the screen, and the user fixed, and receiving a user input on the visibility of the provided images. At least one of the plurality of parameter sets may correspond to a default setting value of parameters for a user of particular visual acuity.

The distance between the electronic device 100 and the screen, the distance between the electronic device 100 and the screen, and the distance between the electronic device 100 and the user, and the distance between the screen and the user according to the locations of the fixed electronic device 100, the screen, and the user, respectively, in the clinical trial may be referred to as a ‘reference distance’.

While increasing the number of clinical trials and varying the conditions may result in obtaining a diverse set of parameters, increasing the number of clinical trials and varying the conditions of the clinical trials is not sufficient to address all of the highly variable changes in the factors involved in adjusting image quality according to the variable locations of the electronic device 100, the screen, and the user. Accordingly, the processor 140 may perform an image quality enhancement function by adjusting at least one parameter included in a plurality of established parameter sets.

The information regarding the user's visual acuity may be stored in the memory 130, and may be obtained as the user enters a numerical value for the visual acuity. In addition, the information regarding the user's visual acuity may be obtained as the electronic device 100 provides an image (e.g., a projected image) and receives a response from the user as to whether the user can identify an object in the image.

When the information regarding the user's visual acuity is obtained, the processor 140 may identify a reference distance corresponding to the user's visual acuity and a set of parameters appropriate for the reference distance, and may provide a projected image based on the identified set of parameters. However, as described above, if the first distance between the electronic device 100 and the screen, the second distance between the electronic device 100 and the user, and the third distance between the screen and the user change from the reference distance, it is desirable to identify a suitable set of parameters based on the changed first distance, second distance, and third distance, or to adjust the set of parameters to be suitable for the changed first distance, second distance, and third distance.

According to various embodiments, the processor 140 may obtain information regarding the brightness of the projected image based on the information regarding the first distance, and may adjust the at least one parameter based on the information regarding the brightness of the projected image. For example, if the first distance is identified as being distant relative to the reference distance, the processor 140 may adjust the at least one parameter such that the brightness of the projected image is higher than the brightness corresponding to the reference distance to prevent and/or reduce the brightness of the projected image from decreasing. If the first distance is identified as being close relative to the reference distance, the processor 140 may adjust the at least one parameter to decrease the brightness of the projected image such that the brightness of the projected image is less than the brightness corresponding to the reference distance to prevent and/or reduce the brightness of the projected image from increasing excessively, and may not adjust the at least one parameter to maintain the brightness of the projected image.

According to various embodiments, the processor 140 may adjust the at least one parameter based on the information regarding the third distance. For example, if the third distance is identified as being distant relative to the reference distance, the processor 140 may adjust the at least one parameter to improve visibility of the projected image to prevent and/or reduce degradation of visibility of the projected image. If the third distance is identified as being close relative to the reference distance, there is no need to prevent and/or reduce the visibility of the projected image from being degraded, so the processor 140 may adjust the at least one parameter to reduce the visibility of the projected image within a limit that does not significantly reduce the visibility of the projected image, or may not adjust the at least one parameter to maintain the visibility of the projected image.

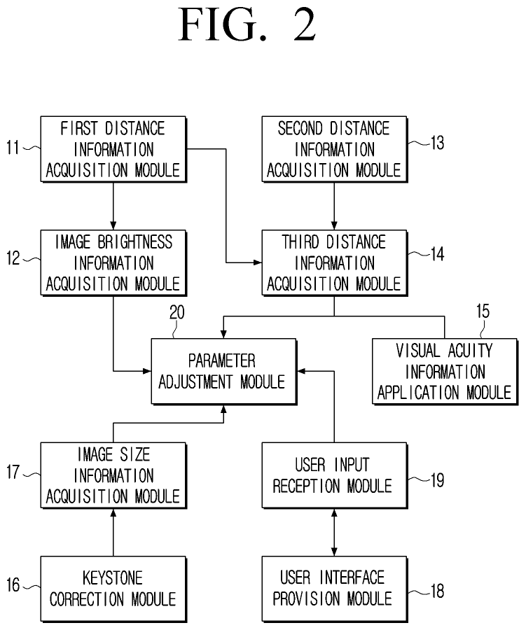

A more specific method related to adjusting the at least one parameter will be described in greater detail below with reference to FIG. 2.

The processor 140 may control the projection unit 110 to emit light corresponding to an image based on the adjusted at least one parameter. In other words, the processor 140 may control the projection unit 110 to emit light by adjusting characteristics of the light corresponding to the image based on adjusted contrast, sharpness, color, and contrast enhancement, as described above.

According to various embodiments, the electronic device 100 may improve the quality of the projected image to be suitable for the distance between the electronic device 100, the screen, and the user. Accordingly, the electronic device 100 may be able to provide the projected image of the quality suitable for the user's visual acuity even when at least one of the locations of the electronic device 100, the screen, and the user changes, particularly if the user of the electronic device 100 has low visual acuity.

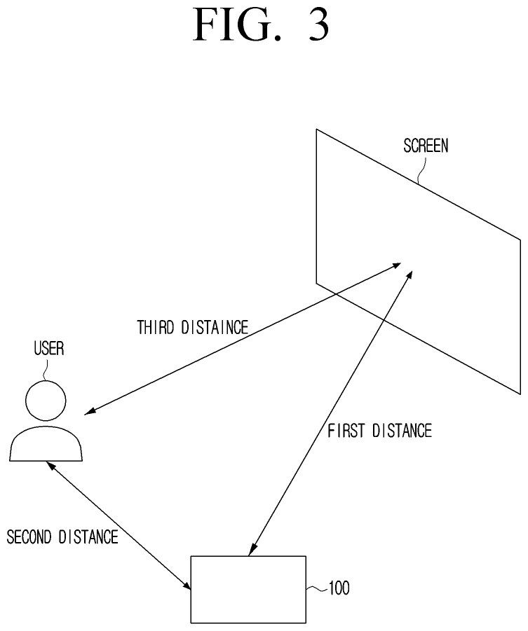

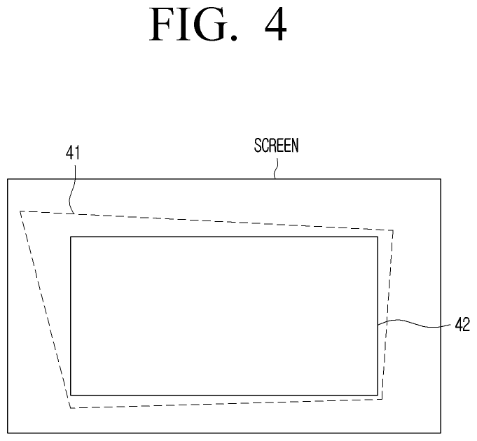

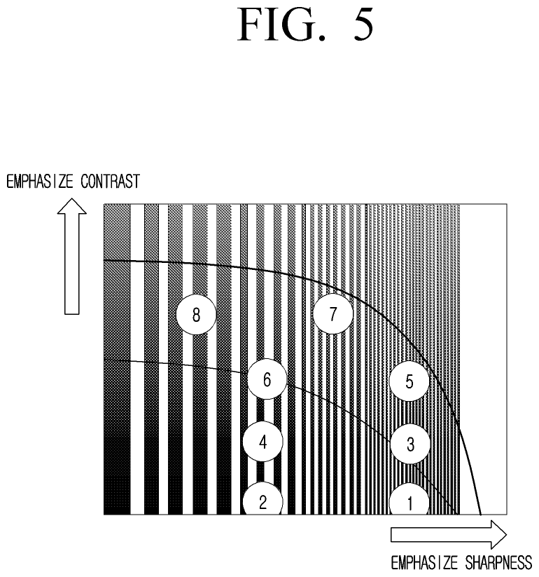

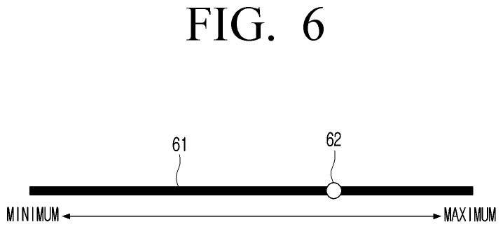

FIG. 2 is a diagram illustrating a plurality of modules according to various embodiments, FIG. 3 is a diagram illustrating an example process of obtaining distance information according to various embodiments, FIG. 4 is a diagram illustrating an example keystone correction and a subsequent process of adjusting a parameter according to various embodiments, FIG. 5 is a diagram illustrating an example user interface according to various embodiments, and FIG. 6 is a diagram illustrating an example user interface according to various embodiments.

The processor 140 may perform a process related to various embodiments of the present disclosure using a plurality of modules. As shown in FIG. 2, the plurality of modules according to the present disclosure may include a first distance information acquisition module 11, an image brightness information acquisition module 12, a second distance information acquisition module 13, a third distance information acquisition module 14, a visual acuity information application module 15, a keystone correction module 16, an image size information acquisition module 17, a user interface provision module 18, a user input reception module 19, and a parameter adjustment module 20. Each of the modules may include various circuitry and/or executable program instructions.

The plurality of modules may be implemented as hardware modules or software modules, and at least some of the modules may include a neural network model. For convenience of explanation, the description will be based on the assumption that the plurality of modules are implemented via the memory 130 and processor 140 of the electronic device 100, but in various embodiments, at least some of the plurality of modules may be implemented by an external device or a server.

Various embodiments of adjusting at least one parameter based on distance information will be described, first with reference to FIG. 3 in conjunction with FIG. 2.

According to various embodiments, the processor 140 may perform an image quality enhancement process adaptive to a variable location of the projection unit. For example, the processor 140 may adjust at least one parameter using the first distance information acquisition module 11, the image brightness information acquisition module 12, or the parameter adjustment module 20.

The ‘first distance information acquisition module 11’ may obtain information regarding a first distance between the electronic device 100 and the screen. When information regarding the first distance is received from the first distance information acquisition module 11, the image brightness information acquisition module 12 may obtain information regarding the size of the projected image based on the first distance information, and may obtain information regarding the brightness of the projected image based on the information regarding the size of the projected image. For example, as shown in FIG. 3, as the first distance increases, the size of the projected image may increase and the brightness of the projected image may decrease.

Accordingly, when information regarding the brightness of the projected image is received from the image brightness information acquisition module 12, the parameter adjustment module 20 may adjust the at least one parameter based on the information regarding the brightness of the projected image.

For example, when the first distance between the electronic device 100 and the screen is doubled compared to a reference distance, the brightness of the projected image may typically be reduced by a quarter compared to the brightness according to the reference distance. Therefore, the parameter adjustment module 20 may adjust the at least one parameter to compensate for the brightness of the projected image that may be reduced by a quarter.

According to various embodiments, the processor 140 may perform an image quality enhancement process adaptive to a variable location of the user. For example, the processor 140 may adjust the at least one parameter using the first distance information acquisition module 11, the second distance information acquisition module 13, the third distance information acquisition module 14, the visual acuity information application module 15, and the parameter adjustment module 20.

The first distance information acquisition module 11 may obtain information regarding the first distance between the electronic device 100 and the screen, and the second distance information acquisition module 13 may obtain information regarding the second distance between the electronic device 100 and the user. When information regarding the first distance is received from the first distance information acquisition module 11 and information regarding the second distance is received from the second distance information acquisition module 13, the third distance information acquisition module 14 may obtain information regarding the third distance between the screen and the user based on the information regarding the first distance and the information regarding the second distance.

The third distance information acquisition module 14 may obtain information regarding the third distance using triangulation, as described above. For example, in FIG. 3, if the first distance is 5 meters, the second distance is 3 meters, and the angle between the line segments representing the first and second distances is 90 degrees, the third distance may be about 5.83 meters.

The visual acuity information application module 15 may obtain information regarding the user's visual acuity, and may apply the information regarding the user's visual acuity to be used to adjust the at least one parameter. For example, the visual acuity information application module 15 may obtain information regarding contrast sensitivity perceivable by the user based on the information regarding the user's visual acuity. The contrast sensitivity may refer to a measure of the user's ability to distinguish patterns or objects of different contrast levels, which may be statistically estimated based on information regarding the user's visual acuity. For example, the visual acuity information application module 15 may estimate contrast sensitivity, which indicates how much contrast the user can perceive based on the user's visual acuity, based on statistical data stored in the memory 130. For example, the contrast sensitivity of the user to the projected image may decrease as the third distance increases, as illustrated in FIG. 3.

Thus, when information regarding the third distance is received from the third distance information acquisition module 14 and information regarding the contrast sensitivity of the user is received from the visual acuity information application module 15, the parameter adjustment module 20 may adjust the at least one parameter based on the information regarding the sensitivity and the information regarding the third distance. In other words, the parameter adjustment module 20 may adjust the at least one parameter to compensate for a decrease in the user's perception of the projected image as the third distance between the screen and the user increases relative to a reference distance.

According to various embodiments described above with reference to FIGS. 2 and 3, the electronic device 100 may enhance the quality of the projected image so that the image quality is optimized to the distance between the electronic device 100, the screen, and the user. Accordingly, the electronic device 100 may be able to provide the projected image of the quality that is suitable for the user's visual acuity, even if at least one of the locations of the electronic device 100, the screen, and the user changes, particularly when the user of the electronic device 100 has low visual acuity (or blind).

Referring to FIG. 4 in conjunction with FIG. 2, various embodiments of adjusting at least one parameter based on the results of a keystone correction are described.

According to various embodiments, the processor 140 may perform an image quality enhancement process that is adaptive to the results of a keystone correction. For example, the processor 140 may further adjust at least one parameter using the keystone correction module 16, the image size information acquisition module 17, and the parameter adjustment module 20.

The processor 140 may receive a request for providing an image. The ‘request for providing an image’ may be received based on an input (e.g., a user input), may be received from an external device, or may be received based on the occurrence of an event predefined as requiring the provision of an image.

For example, the request for providing an image may be received based on a the user's touch input to select an image to be played, a control signal received from a remote control device, or the like. The request for providing an image may be received based on an event occurring in the electronic device 100, such as an event of turning on the power of the electronic device 100, unlocking the electronic device 100, or the like.

When the request for providing an image is received, the processor 140 may control the projection unit 110 to emit light corresponding to the image. For example, based on image data stored in the memory 130, the processor 140 may control the projection unit 110 to emit light corresponding to the image, thereby projecting the image onto the screen.

When the light emitted through the projection unit 110 is projected onto the screen, the keystone correction module 16 may identify the size and shape of the projected image projected onto the screen via the at least one sensor 120. The keystone correction module 16 may perform a keystone correction on the projected image based on the identified size and shape of the projected image. A more specific description regarding the keystone correction will be described in greater detail below with reference to FIG. 7.

The image size information acquisition module 17 may obtain information regarding the size of the projected image corrected according to the keystone correction. As shown in FIG. 4, when the light emitted through the projection unit 110 is projected, the screen may be provided with the projected image having a non-rectangular shape, such as a first image 41 in FIG. 4. When a keystone correction is performed on the projected image, a rectangular-shaped projected image may be provided, as shown in a second image 42 in FIG. 4. As shown in FIG. 4, the size of the projected image 42 corrected according to the keystone correction may be smaller than the size of the projected image 41 before the correction.

Upon receiving information regarding the size of the projected image from the image size information acquisition module 17, the parameter adjustment module 20 may further adjust the at least one parameter based on the information regarding the size of the corrected projected image.

In other words, the size of the projected image 42 corrected according to the keystone correction may be smaller than the size of the projected image 41 before the correction, which may result in degradation of the resolution of the projected image. Therefore, based on information regarding the size of the corrected projected image, the parameter adjustment module 20 may adjust the at least one parameter to compensate for the reduced resolution of the projected image as the size of the projected image is reduced by the keystone correction.

Various embodiments have been described above assuming that the screen is not tilted, but the processor 140 may obtain information regarding the tilt of the screen when the screen is tilted and use the information regarding the tilt for the keystone correction.

According to various embodiments described above with reference to FIGS. 2 and 4, the electronic device 100 may be able to improve the quality of the projected image provided to the user by preventing/reducing degradation of the projected image due to the keystone correction.

Referring to FIGS. 5 and 6 in conjunction with FIG. 2, various embodiments of adjusting at least one parameter based on a user input will be described.

According to various embodiments, the processor 140 may perform an additional image quality enhancement process based on a user input. For example, the processor 140 may further adjust at least one parameter using the user interface provision module 18, the user input reception module 19, and the parameter adjustment module 20.

The user interface provision module 18 may control the projection unit 110 to emit light corresponding to the user interface. Subsequently, the user input reception module 19 may receive a user input to select a UI item from among a plurality of UI items included in the user interface. Upon receiving the user input, the parameter adjustment module 20 may further adjust the at least one parameter based on the user input.

The user interface may include a graph representing contrast sensitivity corresponding to the user's visual acuity and a plurality of UI items representing each of a plurality of locations on the graph. In the example of FIG. 5, the vertical lines and curves of different thicknesses are a graph representing contrast sensitivity corresponding to the user's visual acuity, and a plurality of numbers in circles, from 1 to 8, are the plurality of UI items (or checkpoints) representing each of the plurality of locations on the graph.

When the user selects one of the plurality of UI items corresponding to any one of the numbers 1, 2, 3, 4, 5, 6, 7 and 8 (which may be referred to as numbers 1 to 8) in circles, which corresponds to an area that the user determines to be of poor visibility (e.g., an area that the user wishes to emphasize because the user finds it difficult to distinguish its contrast or sharpness), a user interface as shown in FIG. 6 may be further provided. A first element 61 in the form of a bar in FIG. 6 may represent an area between a minimum level and a maximum level of the at least one parameter, and a second element 62 in the form of a circle in FIG. 6 may represent a level selected based on the user's input. If the second element 62 represents 80% of the maximum level of the parameter, the parameter adjustment module 20 may adjust the parameter to 80% of the maximum level.

In the example of FIG. 5, when the user selects UI items corresponding to numbers 6 to 7, contrast may be adjusted primarily, and when the user selects UI items corresponding to numbers 1 to 5, sharpness may be adjusted primarily. For example, when the user selects the UI item corresponding to number 3, the contrast may be increased or decreased by 30% and the sharpness may be increased or decreased by 70%.

The user input may be received, for example, based on a control signal received from a remote control device for controlling the electronic device 100, and may of course be received in various other ways.

According to various embodiments, the processor 140 may identify a parameter set corresponding to the information regarding the first distance, the information regarding the third distance, and the information regarding the user's visual acuity from among the plurality of parameter sets stored in the memory 130, and adjust the at least one parameter by interpolating the at least one parameter included in each of the identified parameter set and the parameter set that is currently set.

For example, when parameter set A which includes the currently set parameter values, has parameter values of contrast 30, sharpness 10, color 25, and low contrast enhancement, and parameter set B which includes the maximum values for adjusting the image quality, has parameter values of contrast 50, sharpness 20, color 30, and high contrast enhancement, and the current screen size after a keystone correction is ⅓ of the reference screen size, the parameter adjustment module 20 may obtain a new parameter set by adding the values of the parameter set A multiplied by ⅓ and the values of the parameter set B multiplied by ⅔ to obtain a new parameter set, and may adjust the at least one parameter according to the new parameter set.

In another example, when the parameter set A which includes the currently set parameter values, and the parameter set B which includes the maximum values for adjusting the image quality, have the same parameter values as in the above example, and the distance between the screen and the user is ¼ of the reference distance, the parameter adjustment module 20 may obtain a new parameter set by adding the values of the parameter set A multiplied by ¼ and the values of the parameter set B multiplied by ¾, and adjust the at least one parameter according to the new parameter set.

The parameter adjustment module 20 may be implemented as a neural network model, and may utilize the neural network model to adjust the at least one parameter. For example, the neural network model may be trained based on a plurality of parameter sets as described above. In addition, when at least some of information regarding the brightness of the projected image, information regarding the third distance, and information regarding the size of the image corrected according to a keystone correction are input, the neural network model may be trained to output a set of parameters corresponding to the input information. Further, the processor 140 may adjust the at least one parameter based on the set of parameters output by an artificial intelligence model.

While the above has been described with reference to FIG. 2 and the like on the premise that the electronic device 100 performs all of the image quality enhancement functions such as image quality enhancement as the distance between the electronic device 100 and the screen changes, image quality enhancement as the distance between the screen and the user changes, image quality enhancement reflecting the results of a keystone correction, and image quality enhancement in response to receiving a user input, but it is of course possible to perform only some of the above image quality enhancement functions depending on the embodiment.

According to various embodiments described above with reference to FIGS. 2, 5, and 6, the user's satisfaction with the quality of the projected image can be improved by allowing the user to make additional image quality adjustments.

For example, when the user enters information regarding his or her visual acuity, contrast sensitivity corresponding to the user's visual acuity is identified and the quality of the projected image is adjusted based thereon, but if the user is still not satisfied, the quality of the projected image may be further adjusted based on the user's intuitive perception as a user interface that directly indicates the contrast sensitivity is provided.

FIG. 7 is a block diagram illustrating an example configuration of the electronic device 100 according to various embodiments.

As shown in FIG. 7, the electronic device 100 may include not only the projection unit 110, at least one sensor 120, the memory 130, and the processor 140, but also a communicator (e.g., including communication circuitry) 150, an input unit (e.g., including input circuitry) 160, and an output unit (e.g., including output circuitry) 170. However, it should be appreciated that the configurations shown in FIGS. 1 and 7 are merely examples, and that new configurations may be added in addition to those shown in FIGS. 1 and 7, or that some configurations may be omitted, in practicing the present disclosure.

The projection unit 110 according to an embodiment will be described in greater detail, followed by the communicator 150, the input unit 160, and the output unit.

The projection unit 110 may be implemented in a variety of projection methods (e.g., a cathode-ray tube (CRT) method, a liquid crystal display (LCD) method, a digital light processing (DLP) method, a laser method, etc.). For example, the CRT method is basically the same as or similar to a CRT monitor in principle. The CRT method displays an image on a screen by magnifying the image with a lens in front of a CRT. Depending on the number of CRTs, it may be divided into one-tube and three-tube types, and in the case of three-tube type, CRTs of red, green, and blue may be implemented separately.

Another example is the LCD method, which displays an image by transmitting light from a light source onto a liquid crystal. The LCD method is divided into single-plate and three-plate types, and in the case of three-plate type, the light from the light source is separated into red, green, and blue by a dichroic mirror (a mirror that reflects only certain colors of light while letting the rest pass through), and then the light can be gathered back together after passing through the liquid crystal.

Another example is the DLP method, which displays an image using a digital micromirror device (DMD) chip. The projection unit of the DLP method may include a light source, a color wheel, a DMD chip, a projection lens, etc. The light output from the light source can be colored as it passes through the rotating color wheel. After passing through the color wheel, the light is input to the DMD chip. The DMD chip includes multiple microscopic mirrors, which reflect the light input to the DMD chip. The projection lens can be used to magnify the light reflected from the DMD chip to the size of the image.

Another example is the laser method, which involves a Diode Pumped Solid State (DPSS) laser and a galvanometer. The laser that outputs different colors installs three DPSS lasers for each RGB color and then, uses a laser superimposing the optical axes using a special mirror. The galvanometer includes a mirror and a high-powered motor to move the mirror at high speeds. For example, the galvanometer may rotate the mirror at up to 40 KHz/sec. The galvanometer is mounted according to a scan direction, and since a projector typically performs flat scanning, the galvanometer may also be arranged on the x and y axes separately.

The projection unit 110 may include various types of light sources. For example, the projection unit 110 may include a light source of at least one of a lamp, an LED, or a laser.

The projection unit 110 may, for example, and without limitation, output an image in a 4:3 aspect ratio, a 5:4 aspect ratio, a 16:9 wide aspect ratio, or the like, and depending on the aspect ratio, may output light corresponding to the image in various resolutions such as WVGA (854*480), SVGA (800*600), XGA (1024*768), WXGA (1280*720), WXGA (1280*800), SXGA (1280*1024), UXGA (1600*1200), Full HD (1920*1080), and the like.

The projection unit 110 may perform various functions to adjust the output image (e.g., the image projected onto the screen). For example, the projection unit 110 may perform functions such as zoom, keystone, quick-corner (4-corner) keystone, lens shift, etc. to adjust the size and shape of the output image.

For example, the projection unit 110 may enlarge or reduce an image based on the distance from the screen (projection distance). In other words, the projection unit 110 may perform a zoom function based on the distance from the screen. In this case, the zoom function may include a hardware method of adjusting the size of the screen by moving the lens, and a software method of adjusting the size of the screen by cropping the image, etc. When the zoom function is performed, the focus of the image needs to be adjusted. For example, the method of adjusting the focus may include a manual focus method, a motorized focus method, and the like. The manual focus method refers to a method of focusing manually, and the motorized method refers to a method in which the projection unit automatically the focus using a built-in motor when the zoom function is performed. When performing the zoom function, the projection unit 110 may provide a digital zoom function through software, and may provide an optical zoom function by moving the lens through a drive part 120 to perform the zoom function.

The projection unit 110 may perform a keystone correction. If the height is not appropriate for front projection, the screen may be distorted upward or downward. A keystone correction function refers to a function that corrects the distorted screen. For example, if the screen is distorted in the left and right direction, it can be corrected using horizontal keystone, and if the screen is distorted in the up and down direction, it can be corrected using vertical keystone. A quick-corner (4-corner) keystone correction function corrects the screen when the center area of the screen is normal but the corner areas are out of balance. A lens-shift function shifts the screen as it is when an image is off screen.

The projection unit 110 may automatically provide a zoom/keystone/focus function by analyzing the surrounding environment and the projection environment without a user input. Specifically, the projection unit 110 may automatically provide the zoom/keystone/focus function based on the distance of the electronic device 100 from the screen detected through a sensor (depth camera, distance sensor, infrared sensor, illumination sensor, etc.), information regarding the space in which the electronic device 100 is currently located, information regarding the amount of ambient light, etc.

The projection unit 110 may provide an illumination function using a light source. In particular, the projection unit 110 may provide an illumination function by outputting a light source using an LED. According to various embodiments, the projection unit 110 may include a single LED, and according to various embodiments, the electronic device 100 may include a plurality of LEDs. The projection unit 110 may output a light source using a surface-emitting LED according to an embodiment. The surface-emitting LED may refer to an LED having a structure in which an optical sheet is disposed on an upper side of the LED so that the light source is evenly distributed and output. For example, when a light source is output through the LED, the light source may be evenly distributed through the optical sheet, and the light source distributed through the optical sheet may be incident on the display panel.

The projection unit 110 may provide a dimming function for adjusting the intensity of the light source to the user. For example, when a user input for adjusting the intensity of the light source is received from the user via an operation interface (e.g., touch display button or dial), the projection unit 110 may control the LED to output the intensity of the light source corresponding to the received user input.

The projection unit 110 may provide a dimming function based on content analyzed by the processor 140 without a user input. For example, the projection unit 110 may control an LED to output the intensity of the light source based on information regarding the content currently being provided (e.g., content type, content brightness, etc.).

The projection unit 110 may control color temperature under the control of the processor 140. The processor 140 may control the color temperature based on content. For example, when content is identified to be output, the processor 140 may obtain frame-by-frame color information of the content determined to be output. The processor 140 may control the color temperature based on the obtained frame-by-frame color information. The processor 140 may obtain at least one or more dominant colors of the frame based on the frame-by-frame color information. The processor 140 may adjust the color temperature based on the obtained at least one or more dominant colors. For example, the color temperature that can be adjusted by the processor 140 may be classified as a warm type or a cold type. It is assumed that the frame to be output (hereinafter, referred to as the output frame) includes a scene where the fire occurred. The processor 140 may identify (or obtain) that the dominant color is red based on the color information included in the current output frame. The processor 140 may then identify a color temperature corresponding to the identified dominant color (red). The color temperature corresponding to red may be a warm type. The processor 140 may use an artificial intelligence model to obtain the color information or dominant color of the frame. According to various embodiments, the artificial intelligence model may be stored in the electronic device 100 (e.g., memory 130). According to various embodiments, the artificial intelligence model may be stored in an external server capable of performing communication with the electronic device 100.

The communicator 150 includes a circuit and may perform communication with an external device. For example, the processor 140 may receive various data or information from an external device connected via the communicator 150, and may transmit various data or information to the external device.

The communicator 150 may include at least one of a Wi-Fi module, a Bluetooth module, a wireless communication module, an NFC module, or a Ultra-Wide Band (UWB) module. Specifically, each of the Wi-Fi module and Bluetooth module may perform communication using a Wi-Fi method and a Bluetooth method, respectively. When using a Wi-Fi module or a Bluetooth module, various connection information such as SSID is first transmitted and received, and various information may be transmitted and received after establishing a communication connection using the same.

In addition, the wireless communication module may perform communication according to various communication standards such as IEEE, Zigbee, 3^{rd} Generation (3G), 3^{rd} Generation Partnership Project (3GPP), Long Term Evolution (LTE), 5^{th} Generation (5G), etc. In addition, the NFC module may perform communication in a Near Field Communication (NFC) communication method using various RF-ID frequency bands such as 135 kHz, 13.56 MHz, 433 MHz, 860˜960 MHz, and 2.45 GHz. In addition, through communication between UWB antennas, the UWB module may accurately measure Time of Arrival (ToA), which is the time for a pulse to reach a target, and Ange of Arrival (AoA), which is the angle of arrival of the pulse at the transmitter, and accordingly, may accurately recognize precise distance and position indoors within an error range of tens of centimeters.

For example, according to various embodiments, the processor 140 may receive, via the communicator 150, from a remote control device for controlling the electronic device 100, a control signal corresponding to a user input for entering information regarding the user's visual acuity, a control signal corresponding to a request for providing an image, a control signal corresponding to a user input for selecting one of a plurality of UI items included in the user interface, and the like.

The input unit 160 includes a circuit, and the processor 140 may receive user commands to control the operation of the electronic device 100 via the input unit 160. For example, the input unit 160 may include configurations such as a microphone, a camera, and a remote control signal receiver. In addition, the input unit 160 may be implemented as a touch screen that is embedded in a display. For example, the microphone may receive a voice signal and convert the received voice signal into an electrical signal.

For example, according to various embodiments, the processor 140 may receive, via the input unit 160, a user input for entering information regarding the user's visual acuity, a user input in response to a request for providing an image, a user input for selecting one of a plurality of UI items included in the user interface, and the like.

The processor 140 may receive, via the input unit 160, a user input to turn on or off an image quality mode function exclusively for low-vision people (or the visually impaired), and when the image quality mode function for low-vision people is turned on, parameter adjustment according to the above-described various embodiments may be performed.

The output unit 170 may include a circuit, and the processor 140 may output, via the output unit, various functions that can be performed by the electronic device 100. The output unit 170 may include at least one of a display, a speaker, or an indicator.

The display may output image data under the control of the processor 140. For example, the display may output an image prestored in the memory 130 under control of the processor 140. For example, the display according to an embodiment may display a user interface stored in the memory 130. The display may be implemented as a liquid crystal display panel (LCD), organic light emitting diodes (OLED), or the like, and in some cases, the display may also be implemented as a flexible display, a transparent display, or the like. However, the present disclosure is not limited to any particular type of display.

The speaker may output audio data under the control of the processor 140, and the indicator may be illuminated under the control of the processor 140.

For example, according to various embodiments, the processor 140 may control the display to display a user interface for requesting input of information regarding visual acuity, a user interface for requesting a user input to select a desired image, and a user interface for receiving a user input to improve image quality. In other words, various user interfaces including the user interfaces described with reference to FIGS. 5 and 6, may be provided to the user in a manner in which the user interfaces are projected onto the screen via the projection unit 110, or in a manner in which the user interfaces are displayed in the display included in the electronic device 100.

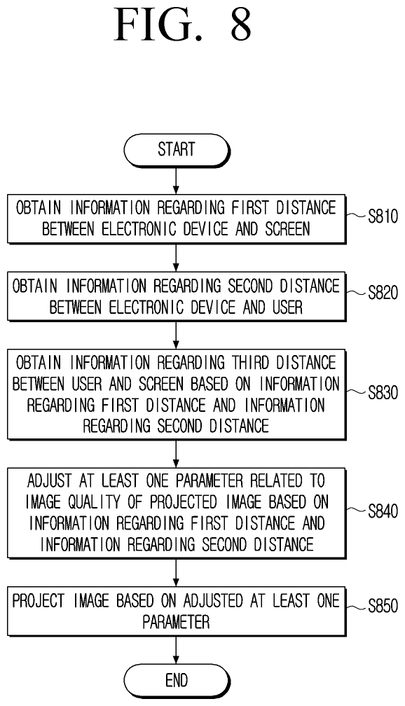

FIG. 8 is a flowchart illustrating an example method of controlling the electronic device 100 according to various embodiments.

The electronic device 100 may obtain information regarding a first distance between the electronic device 100 and the screen (S810). The electronic device 100 may obtain information regarding a second distance between the electronic device 100 and the user (S820). For example, the electronic device 100 may obtain the information regarding the first distance and the information regarding the second distance using at least one of various sensors capable of obtaining information regarding a distance to an object.

The electronic device 100 may obtain information regarding a third distance between the user and the screen based on the information regarding the first distance and the information regarding the second distance (S830). For example, the electronic device 100 may obtain the information regarding the third distance using triangulation.

The electronic device 100 may adjust at least one parameter related to the quality of the projected image based on the information regarding the first distance, the information regarding the third distance, and the information regarding the user's visual acuity (S840).

The term ‘at least one parameter’ may be used to collectively refer to a parameter related to the image quality of the projected image, and may be substituted for terms such as ‘image quality setting value’, ‘image quality adjustment value’, and the like. Specifically, the at least one parameter may include parameters for at least one of contrast, sharpness, color, or contrast enhancement of the projected image.

According to various embodiments, the electronic device 100 may obtain information regarding brightness of the projected image based on the information regarding the first distance, and may adjust at least one parameter based on the information regarding the brightness of the projected image. For example, if the first distance is identified as being distant relative to the reference distance, the electronic device 100 may adjust the at least one parameter such that the brightness of the projected image is higher than the brightness corresponding to the reference distance in order to prevent and/or reduce the brightness of the projected image from decreasing. If the first distance is identified as being close relative to the reference distance, the electronic device 100 may adjust the at least one parameter to decrease the brightness of the projected image to be less than the brightness corresponding to the reference distance to prevent and/or reduce the brightness of the projected image from increasing excessively, and the electronic device 100 may not adjust the at least one parameter to maintain the brightness of the projected image.

According to various embodiments, the electronic device 100 may adjust at least one parameter based on the information regarding the third distance. For example, if the third distance is identified as being distant relative to the reference distance, the electronic device 100 may adjust the at least one parameter to improve the visibility of the projected image to avoid degrading the visibility of the projected image. If the third distance is identified as being close relative to the reference distance, there is no need to prevent and/or reduce the visibility of the projected image from being degraded, so the electronic device 100 may adjust the at least one parameter to reduce the visibility of the projected image within a limit that does not significantly reduce the visibility of the projected image, or may not adjust the at least one parameter to maintain the visibility of the projected image.

The electronic device 100 may project an image based on the adjusted at least one parameter (S850). The electronic device 100 may control the projection unit 110 to emit light by adjusting the characteristics of the light corresponding to the image based on adjusted contrast, sharpness, color, and contrast enhancement, as described above

According to various embodiments, when a request for providing an image is received, the electronic device 100 may project light corresponding to the image. When the light emitted through the projection unit 110 is projected onto the screen, the electronic device 100 may identify, via the at least one sensor 120, the size and shape of the projected image projected onto the screen. The electronic device 100 may perform a keystone correction on the projected image based on the identified size and shape, and may obtain information regarding the size of the corrected projected image corrected according to the keystone correction. The electronic device 100 may further adjust the at least one parameter based on the information regarding the size of the corrected projected image.

According to various embodiments, the electronic device 100 may project light corresponding to a user interface. Upon receiving a user input to select one UI item from among a plurality of UI items included in the user interface, the electronic device 100 may adjust at least one parameter based on the user input.

The controlling method of the electronic device 100 according to the above-described example embodiments may be implemented as a program and provided to the electronic device 100. For example, the program including the controlling method of the electronic device 100 may be stored and provided in a non-transitory computer readable medium.

For example, in a non-transitory computer-readable recording medium including a program that when executed by at least one processor of an electronic device, causes the electronic device to perform operations including: obtaining information regarding a first distance between the electronic device (100) and a screen; obtaining information regarding a second distance between the electronic device (100) and a user, obtaining information regarding a third distance between the user and the screen based on the information regarding the first distance and the information regarding the second distance; adjusting, based on the information regarding the first distance, the information regarding the third distance, and the information regarding the user's visual acuity, at least one parameter related to a quality of the projected image; and projecting the image based on the adjusted at least one parameter.

In the above, a controlling method of the electronic device 100 and a computer-readable recording medium including a program that executes the controlling method of the electronic device 100 have been briefly described above, but this is simply to avoid redundant description, and various embodiments of the electronic device 100 may also be applicable to a controlling method of the electronic device 100 and a computer-readable recording media including a program that executes the controlling method of the electronic device 100.

Functions related to artificial intelligence according to an embodiment is operated through the one or more processors 140 and the memory 130 of the electronic device 100. The processor 140 may include one or a plurality of processors 140. The one or more processors 140 may include at least one of a Central Processing Unit (CPU), a Graphic Processing Unit (GPU), or a Neural Processing Unit (NPU), but are not limited thereto.

The CPU may be a generic-purpose processor 140 which may perform not only general calculations but also artificial intelligence calculations, and may efficiently execute complex programs through a multi-layered cache structure. The CPU may be advantageous for a serial processing method that enables organic linkage between the previous calculation result and the next calculation result through sequential calculation. The generic-purpose processor 140 is not limited to the above examples except for a case where the processor is specified as the above-mentioned CPU.

The GPU may include a processor 140 for large-scale operations such as floating-point operations used for graphics processing, and may perform the large-scale operations in parallel by integrating a large number of cores. In particular, the GPU may be advantageous for a parallel processing method such as a convolution operation or the like compared to the CPU. The GPU may be used as the co-processor 140 to supplement a function of the CPU. The processor for the large-scale operations is not limited to the above example except for a case where the processor 140 is specified as the above-mentioned GPU.

The NPU may include the processor 140 specialized in artificial intelligence calculation using an artificial neural network, and each layer included in the artificial neural network may be implemented in hardware (e.g., silicon). The NPU is specially designed based on requirements of a company, and may thus have a lower degree of freedom than the CPU or the GPU. However, the NPU may efficiently process the artificial intelligence calculation required by the company. As the processor specialized for the artificial intelligence calculation, the NPU may be implemented in various forms such as a tensor processing unit (TPU), an intelligence processing unit (IPU), or a vision processing unit (VPU). The artificial intelligence processor 140 is not limited to the above example except for a case where the processor 140 is specified as the above-mentioned NPU.

In addition, one or more processors 140 may be implemented in a system on chip (SoC). The SoC may further include the memory 130 and a network interface such as a bus for data communication between the processor 140 and the memory 130, in addition to the one or more processors 140.

In case that the system on chip (SoC) included in the electronic device 100 includes a plurality of processors 140, the electronic device 100 may use some of the plurality of processors 140 to perform the artificial intelligence calculation (e.g., calculation related to the learning or inference of an artificial intelligence model). For example, the electronic device 100 may perform the artificial intelligence calculation using at least one of the GPU, NPU, VPU, TPU, or a hardware accelerator that is specialized for the artificial intelligence calculation such as convolution calculation and matrix multiplication calculation among the plurality of processors 140. However, this is merely an example, and the artificial intelligence calculation may be processed using the generic-purpose processor 140 such as a CPU.

In addition, the electronic device 100 may perform calculation for a function related to the artificial intelligence using multi-cores (e.g., dual-core or quad-core) included in one processor 140. For example, the electronic device 100 may perform the artificial intelligence calculation such as the convolution calculation and the matrix multiplication calculation in parallel using the multi-cores included in the processor 140.

The one or more processors 140 are controlled to process the input data according to predefined operation rules or artificial intelligence models stored in the memory 130. The predefined operation rules or artificial intelligence models are characterized as having been created through learning.

Created through learning may refer, for example, to applying a learning algorithm to a plurality of training data, predefined operation rules or artificial intelligence models of desired characteristics being created. Such learning can be performed on the device itself, where the artificial intelligence according to an embodiment is performed, or on a separate server/system.

An artificial intelligence model may include a plurality of neural network layers. Each layer has at least one weight value, and the computation of the layers is performed using the computation results of the previous layers and at least one predefined computation. Examples of neural networks include convolutional neural networks (CNN), deep neural networks (DNN), recurrent neural networks (RNN), restricted Boltzmann machines (RBM), deep belief networks (DBN), bidirectional recurrent deep neural networks (BRDNN), deep Q-networks, and Transformer, but are not limited to the above-described examples, except where specified.

A learning algorithm is a method of training a target device (e.g., a robot) using multiple training data to enable the target device to make decisions or predictions on its own. Examples of learning algorithms include supervised learning, unsupervised learning, semi-supervised learning, or reinforcement learning, and the learning algorithms of this disclosure are not limited to the above-described examples, except where specified.

The computer-readable storage medium may be provided in the form of a non-transitory storage medium. Here, ‘non-transitory storage medium’ may refer, for example, to a tangible device and may not contain signals (e.g., electromagnetic waves). This term does not distinguish between a case in which data is stored semi-permanently in a storage medium and a case in which data is stored temporarily. For example, a ‘non-transitory storage medium’ may include a buffer in which data is temporarily stored.

According to an embodiment, the methods according to the various embodiments described above may be included and provided in a computer program product. The computer program product may be traded as a product between a seller and a purchaser. The computer program product can be distributed in the form of a storage medium that is readable by machines (e.g.: a compact disc read only memory (CD-ROM)), or distributed directly on-line (e.g.: download or upload) through an application store (e.g.: Play Store™), or between two user devices (e.g.: smartphones). In the case of on-line distribution, at least a portion of a computer program product (e.g.: a downloadable app) may be stored in a storage medium readable by machines such as the server of the manufacturer, the server of the application store, or the memory 130 of the relay server at least temporarily, or may be generated temporarily.

As described above, each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before being integrated in the same or similar manner.

Operations performed by the modules, the programs or other components according to the various embodiments may be executed in a sequential manner, a parallel manner, an iterative manner or a heuristic manner, and at least some of the operations may be performed in a different order or be omitted, or other operations may be added.

Meanwhile, terms “˜er/or” or “module” used in the disclosure may include units configured by hardware, software, or firmware, and may be used compatibly with terms such as, for example, logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

Various embodiments according to the present disclosure may be implemented in software including an instruction stored in a machine-readable storage medium (e.g., computers). A machine may be a device that invokes the stored instruction from the storage medium and is operated based on the invoked instruction, and may include the electronic apparatus (e.g., electronic device 100) according to embodiments disclosed herein.

In case that the instruction is executed by the processor, the processor may directly perform a function corresponding to the instruction or other components may perform the function corresponding to the instruction under control of the processor. The instruction may include codes provided or executed by a compiler or an interpreter.

The disclosure has been illustrated and described with reference to various example embodiments, and it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a projection unit including a projector;
at least one sensor;
a memory configured to store at least one instruction; and
at least one processor, comprising processing circuitry, individually and/or collectively, configured to execute the at least one instruction,
wherein at least one processor, individually and/or collectively, is configured to:
obtain information regarding a first distance between the electronic device and a screen through the at least one sensor;
obtain information regarding a second distance between the electronic device and a user through the at least one sensor;
obtain information regarding a third distance between the user and the screen based on the information regarding the first distance and the information regarding the second distance;
adjust at least one parameter related to a quality of a projected image based on the information regarding the first distance, the information regarding the third distance and information regarding visual acuity of the user; and
control the projection unit to emit light corresponding to the image based on the adjusted at least one parameter.

2. The device as claimed in claim 1, wherein the at least one parameter includes a parameter regarding at least one of contrast, sharpness, color, or contrast enhancement of the projected image.

3. The device as claimed in claim 1, wherein at least one processor, individually and/or collectively, is configured to:
obtain information regarding a size of the projected image based on the information regarding the first distance;
obtain information regarding brightness of the projected image based on the information regarding the size of the projected image; and
adjust the at least one parameter based on the information regarding the brightness of the projected image.

4. The device as claimed in claim 1, wherein at least one processor, individually and/or collectively, is configured to:
obtain information regarding contrast sensitivity perceivable by the user based on the information regarding the visual acuity of the user; and
adjust the at least one parameter based on the information regarding the contrast sensitivity and the information regarding the third distance.

5. The device as claimed in claim 1, wherein at least one processor, individually and/or collectively, is configured to:
based on a request for providing an image being received, control the projection unit to emit light corresponding to the image;
based on the light emitted through the projection unit being projected onto a screen, identify a size and shape of the projected image projected onto the screen through the at least one sensor;
perform a keystone correction on the projected image based on the identified size and shape;
obtain information regarding a size of the projected image corrected according to the keystone correction; and
further adjust the at least one parameter based on the information regarding the size of the corrected projected image.

6. The device as claimed in claim 5, wherein at least one processor, individually and/or collectively, is configured to:
further adjust the at least one parameter based on the information regarding the size of the corrected projected image to compensate for degradation in resolution of the projected image based on the size of the projected image being reduced by the keystone correction.

7. The device as claimed in claim 6, wherein at least one processor, individually and/or collectively, is configured to:
identify a set of parameters corresponding to the information regarding the size, the first distance information, the third distance information, and the information regarding the visual acuity of the user from among a plurality of sets of parameters stored in the memory; and
adjust the at least one parameter by interpolating the identified set of parameters and at least one parameter included in each of a set of parameters that are currently set.

8. The device as claimed in claim 1, wherein at least one processor, individually and/or collectively, is configured to:
control the projection unit to emit light corresponding to a user interface (UI); and
based on an input for selecting one of a plurality of UI items included in the user interface being received, adjust the at least one parameter based on the input.

9. The device as claimed in claim 8, wherein the user interface includes a graph representing contrast sensitivity corresponding to the visual acuity of the user and a plurality of UI items representing each of a plurality of locations of the graph.

10. The device as claimed in claim 1, wherein at least one processor, individually and/or collectively, is configured to:
obtain a set of parameters for adjusting at least one parameter related to a quality of a projected image by inputting the information regarding the first distance, the information regarding the third distance and the information regarding the visual acuity of the user to a trained neural network model; and
adjust the at least one parameter based on the obtained set of parameters.

11. A method of controlling an electronic device comprising:
obtaining information regarding a first distance between the electronic device and a screen through the at least one sensor;
obtaining information regarding a second distance between the electronic device and a user through the at least one sensor;
obtaining information regarding a third distance between the user and the screen based on the information regarding the first distance and the information regarding the second distance;
adjusting at least one parameter related to a quality of a projected image based on the information regarding the first distance, the information regarding the third distance and information regarding visual acuity of the user; and
projecting the image based on the adjusted at least one parameter.

12. The method as claimed in claim 11, wherein the at least one parameter includes a parameter regarding at least one of contrast, sharpness, color, or contrast enhancement of the projected image.

13. The method as claimed in claim 11, further comprising:
obtaining information regarding a size of the projected image based on the information regarding the first distance; and
obtaining information regarding brightness of the projected image based on the information regarding the size of the projected image,
wherein the adjusting at least one parameter comprises adjusting the at least one parameter based on the information regarding the brightness of the projected image.

14. The method as claimed in claim 11, further comprising:
obtaining information regarding contrast sensitivity perceivable by the user based on the information regarding the user's visual acuity; and
wherein the adjusting at least one parameter comprises adjusting the at least one parameter based on the information regarding the contrast sensitivity and the information regarding the third distance.

15. The method as claimed in claim 11, further comprising:
based on a request for providing an image being received, controlling the projection unit to emit light corresponding to the image;
based on the light emitted through the projection unit being projected onto a screen, identifying a size and shape of the projected image projected onto the screen through the at least one sensor;
performing a keystone correction on the projected image based on the identified size and shape;
obtaining information regarding a size of the projected image corrected according to the keystone correction; and
further adjusting the at least one parameter based on the information regarding the size of the corrected projected image.
